(19) United States
(12) Patent Application Publication
(10) Pub. No.: US 2026/0072202 A1
(43) Pub. Date: Mar. 12, 2026

(54) COMPOUND LENS

(71) Applicant: OMNIVISION TECHNOLOGIES, INC., Santa Clara, CA (US)

(72) Inventors: I Lung Lu, Hsinchu City (TW); Kuang Ju Wang, Hsinchu City (TW); Jau Jan Deng, Hsinchu City (TW)

(73) Assignee: OMNIVISION TECHNOLOGIES, INC., Santa Clara, CA (US)

(21) Appl. No.: 18/830,562

(22) Filed: Sep. 10, 2024

(51) Int. Cl. G02B 3/02

(52) U.S. Cl. CPC G02B 3/02

(57) ABSTRACT

A compound lens includes four coaxially aligned lenses: (i) a first substrate, and a first lens and, in order of increasing distance therefrom, and on a same side thereof, (ii) a second lens, a second substrate, a third lens, a third substrate, and a fourth lens. The first lens is negative lens. The second lens, the third lens and the fourth lens are positive lenses.

### BACKGROUND

### Technical Field

The disclosure relates to a compound lens.

### Description of Related Art

Medical endoscopy, machine vision, eye/face tracking, and other applications require a compact camera that is able to capture a quality image with a wide field-of-view, and is manufacturable via a low-cost process compatible with high-volume manufacturing.

A four lens optical system is designed for improving image quality of three lens optical system. For example, the lenses of the optical system could be sequentially designed as negative, positive, negative, and positive lenses along the optical axis. However, camera with higher sensor resolution is accompanied by a larger sensor size, and larger sensor size results in a larger lateral size of the lens. For example, it is difficult to keep the lens size less than 1.5 mm×1.5 mm in high sensor resolution application.

### SUMMARY

The disclosure is directed to a compound lens, which could provide smaller lens size.

A compound lens includes four coaxially aligned lenses: (i) a first substrate, and a first lens and, in order of increasing distance therefrom, and on a same side thereof, (ii) a second lens, a second substrate, a third lens, a third substrate, and a fourth lens. The first lens is negative lens. The second lens, the third lens and the fourth lens are positive lenses.

In view of the above, the compound lens in the embodiments includes a first lens, a second lens, a third lens, and a fourth lens, and the refractive powers of lenses are designed as: the first lens is negative lens, and the second lens, the third lens and the fourth lens are positive lenses. Thus, comparing to the design that the first lens and the third lens are negative lens, and the second lens and the fourth lens are positive lens, when the incident lights reach the surface of the third lens with the positive refractive power, the incident lights are converged, so that the lateral size of the compound lens could be further designed to be smaller.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a cross-sectional view of a ventricle that includes a lesion imaged by an endoscope camera that includes a compound lens, in an embodiment.

FIG. 2A is a schematic cross-sectional view of a compound lens, which is a first embodiment of the compound lens of FIG. 1.

FIG. 2B is a schematic diagram of the definition of diagonal diameter of the image plane in FIG. 2A.

FIG. 3A to 3D are diagrams of the longitudinal spherical aberration and various aberrations of the compound lens according to the first embodiment in FIG. 2A.

FIG. 4 is a schematic cross-sectional view of a compound lens, which is a second embodiment of the compound lens of FIG. 1.

FIG. 5A to 5D are diagrams of the longitudinal spherical aberration and various aberrations of the compound lens according to the second embodiment in FIG. 4.

FIG. 6 is a schematic cross-sectional view of a compound lens, which is a third embodiment of the compound lens of FIG. 1.

FIG. 7A to 7D are diagrams of the longitudinal spherical aberration and various aberrations of the compound lens according to the third embodiment in FIG. 6.

### DESCRIPTION OF THE EMBODIMENTS

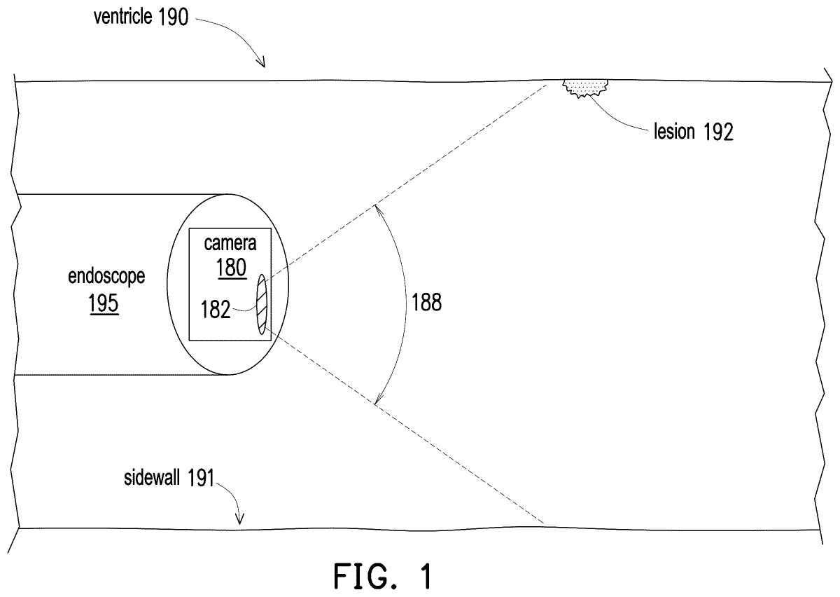

FIG. 1 is a cross-sectional view of a ventricle that includes a lesion imaged by an endoscope camera that includes a compound lens, in an embodiment. Referring to FIG. 1, FIG. 1 shows an endoscope 195 is inside a ventricle 190 that includes a lesion 192. The lesion 192 is on a ventricle sidewall 191. The ventricle 190 may be, for example, a portion of an esophagus or an intestine. The endoscope 195 includes a camera 180, which images lesion 192. The camera 180 includes a lens 182, which in part determines a field of view 188 of camera 180. Without departing from the scope hereof, camera 180 may be part of a device other than an endoscope, such as a security camera, mobile device, or other consumer electronics product.

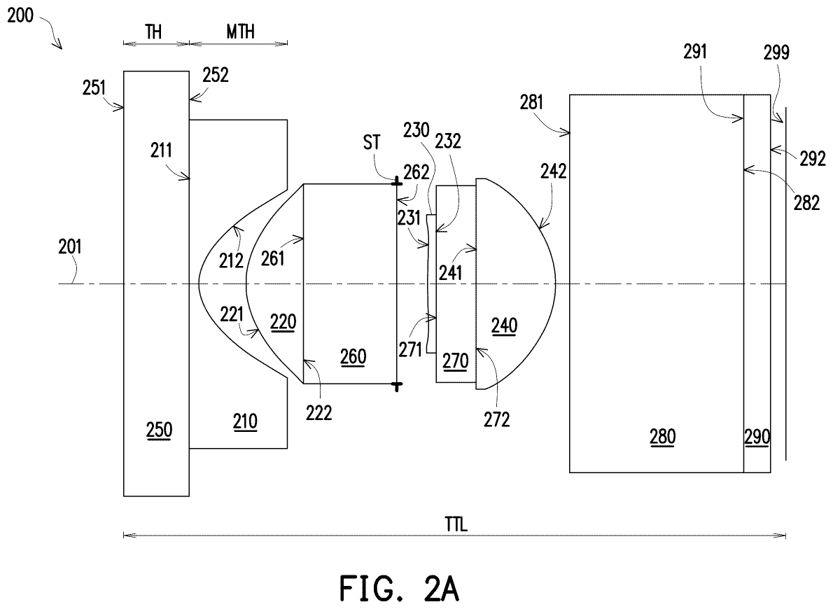

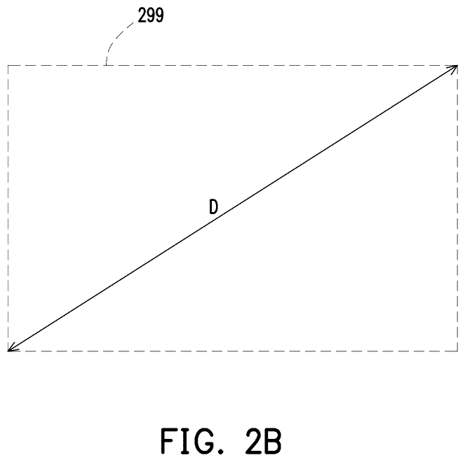

FIG. 2A is a schematic cross-sectional view of a compound lens, which is a first embodiment of the compound lens of FIG. 1. Referring to FIG. 2A, FIG. 2A shows a compound lens 200, which is an example of lens 182 of camera 180 in FIG. 1. The compound lens 200 in this embodiment includes four coaxially aligned lenses along an optical axis 201: (i) a first substrate 250, and a first lens 210 and, in order of increasing distance therefrom, and on a same side thereof, (ii) a second lens 220, a second substrate 260, a third lens 230, a third substrate 270, and a fourth lens 240. The first lens 210 is negative lens (i.e., has negative refracting power). The second lens 220, the third lens 230 and the fourth lens 240 are positive lenses (i.e., has positive refracting power).

Specifically, in this embodiment, the first substrate 250, the first lens 210, the second lens 220, the second substrate 260, the third lens 230, the third substrate 270, and the fourth lens 240 respectively has a surface 251, a surface 211, a second lens surface 221, a second planar surface 261, a third lens surface 231, a third planar surface 271, and a surface 241 facing away from an image plane 299, which could be represented as object-side surface. The first substrate 250, the first lens 210, the second lens 220, the second substrate 260, the third lens 230, the third substrate 270, and the fourth lens 240 respectively further has a first planar surface 252, a first lens surface 212, a surface 222, a surface 262, a surface 232, a surface 272, and a fourth lens surface 242 facing the image plane 299, which could be represented as image-side surface.

In this embodiment, the first substrate 250 could be a glass substrate, but the disclosure is not limited thereto. The first lens 210 may be a plano-concave lens. The first lens 210 is bonded to the first planar surface 252, i.e., the surface 211 of the first lens 211 and the first planar surface 252 of the first substrate 250 are coplanar. Moreover, the first lens 210 has the first lens surface 212 which is paraxial concave facing the image plane 299.

In this embodiment, the second substrate 260 could be a glass substrate, but the disclosure is not limited thereto. The second lens 220 may be a plano-convex lens. The second lens 220 is bonded to the second planar surface 261, i.e., the surface 222 of the second lens 220 and the second planar surface 261 of the second substrate 260 are coplanar. Moreover, the second lens 220 has the second lens surface 221 which is paraxial convex facing away from the image plane 299.

In this embodiment, the third substrate 270 could be a glass substrate, but the disclosure is not limited thereto. The third lens 230 may be a plano-convex lens. The third lens 230 is bonded to the third planar surface 271, i.e., the surface 232 of the third lens 230 and the third planar surface 271 of the third substrate 270 are coplanar. Moreover, the third lens 230 has the third lens surface 231 which is a paraxial convex facing away the image plane 299.

In this embodiment, the fourth lens 240 may be a plano-convex lens. The fourth lens 240 is bonded to the fourth planar surface 272, i.e., the surface 241 of the fourth lens 240 and the fourth planar surface 272 of the third substrate 270 are coplanar. Moreover, the fourth lens 240 has the fourth lens surface 242 which is a paraxial convex facing the image plane 299.

TABLE 1
First embodiment
Fno = 3.5, FOV = 120°, EFL = 0.42 mm

| | | Radius of | | Refrac- | | |
|---|---|---|---|---|---|---|
| | | curvature | Thickness | tive | Abbe | Aperture |
| Element | Type | (mm) | (mm) | Index | number | (mm) |
| Object | Sphere | Infinity | 15 | | | |
| 251 | Sphere | Infinity | 0.25 | 1.52 | 63 | 0.7995 |
| 211 | Sphere | Infinity | 0.035 | 1.51 | 62 | 0.6198 |
| 212 | Asphere | 0.1771 | 0.1772 | | | 0.3547 |
| 221 | Asphere | 0.3175 | 0.2179 | 1.60 | 28 | 0.3422 |
| 261 | Sphere | Infinity | 0.35 | 1.52 | 63 | 0.3213 |
| Stop ST | Sphere | Infinity | 0.1167 | | | 0.0915 |
| 231 | Asphere | 2.5587 | 0.0322 | 1.51 | 62 | 0.2343 |
| 271 | Sphere | Infinity | 0.15 | 1.52 | 63 | 0.2606 |
| 241 | Sphere | Infinity | 0.2995 | 1.51 | 62 | 0.3714 |
| 242 | Asphere | −0.3473 | 0.0968 | | | 0.3974 |
| 281 | Sphere | Infinity | 0.655 | 1.52 | 63 | 0.5103 |
| 291 | Sphere | Infinity | 0.1 | 1.52 | 63 | 0.6416 |
| Air gap | Sphere | Infinity | 0.01 | | | 0.6616 |
| 299 | Sphere | Infinity | 0 | | | 0.6650 |

Table 1 shows other detailed optical data of the first embodiment. A F-number (Fno) of the compound lens 200 according to the first embodiment is 3.5, a field of view (FOV) is 120 degrees, and an effective focal length (EFL) is 0.42 millimeters (mm).

TABLE 2

| Surface | K | a₄ | a₆ | a₈ | a₁₀ |
|---|---|---|---|---|---|
| 212 | −0.9249487 | −5.354349151 | 46.96629832 | −621.360963 | 7743.028098 |
| 221 | −0.3560184 | −2.916551432 | 5.219643699 | −334.425588 | 7939.963852 |
| 231 | 1.59089641 | −5.303406849 | 61.75885682 | −937.42978 | 444.5100936 |
| 242 | −4.4729749 | −9.273911101 | 103.2856382 | −1287.89472 | 13557.00277 |

| Surface | a₁₂ | a₁₄ | a₁₆ |
|---|---|---|---|
| 212 | −58289.103 | 192591.54 | −272382.24 |
| 221 | −114577.54 | 736098.485 | −1958877.1 |
| 231 | 7.694E−07 | 1.1038E−06 | |
| 242 | −107101.82 | 497744.034 | −1015879.7 |

Table 2 shows the aspheric surface parameters of the compound lens 200 according to the first embodiment of the disclosure. The units of quantities in Table 2 are expressed in millimeters. In the embodiment, the first lens surface 212 of the first lens 210, the second lens surface 221 of the second lens 220, the third lens surface 231 of the third lens 230, and the fourth lens surface 242 of the fourth lens 240 are aspheric surfaces. These aspheric surfaces are defined by the following formula:

$${Z}_{s a g} = \frac{{r}^{2}}{R} / ( 1 + \sqrt{1 - ( 1 + K ) \frac{{r}^{2}}{{R}^{2}}} ) + {\sum }_{i = 1}^{n} {a}_{i} \times {r}^{i} \qquad ( 1 )$$

where,
R: a radius of curvature of the lens surface near to the optical axis 201,
Z_{sag}: a function of radial coordinate r, where directions z and r are respectively parallel to and perpendicular to optical axis 201,
K: a conic constant, and
aᵢ: an i-th aspheric surface coefficient.

In addition, the compound lens 200 in this embodiment further includes a stop ST, a filter 280 and a cover glass 290 sequentially arranges along the optical axis 201. The stop ST is disposed between the second substrate 260 and the third lens 230. The filter 280 is disposed between the fourth lens 240 and the cover glass 290. Moreover, the filter 280 and the cover glass 290 respectively has a surface 281 and 291 facing away from the image plane 299, which could be represented as object-side surface. The filter 280 and the cover glass 290 respectively further has a surface 282 and 292 facing the image plane 299, which could be represented as image-side surface. The filter 280 may be an IR cut filter, but the disclosure is not limited thereto.

FIG. 2B is a schematic diagram of the definition of diagonal diameter of the image plane in FIG. 2A. Referring to FIGS. 2A and 2B, in this embodiment, the compound lens 200 satisfies a following conditional expression: 1.3<TTL/D<2.1, where TTL is a total track length from the surface 251 of the first substrate 250 facing away from the image plane 299 to the image plane 299, and D is a diagonal diameter of the image plane 299, wherein the image plane 299 may be represented as a sensing surface of a sensor of the camera 180. Thus, since the compound lens 200 of the disclosure satisfies the conditional expression of 1.3<TTL/D<2.1, the lens size of the lateral direction in the compound lens 200 could be miniaturized.

Furthermore, in this embodiment, the compound lens 200 satisfies a following conditional expression: −2.1<R4/F<−0.8, where R4 is a radius of the fourth lens surface 242 of the fourth lens 240 facing the image plane 299, and F is the effective focal length of the compound lens 200. Thus, since the compound lens 200 of the disclosure satisfies the conditional expression of-2.1<R4/F<−0.8, the system size (i.e., the total track length TTL) of the compound lens 200 could be shorten and the lens size of the lateral direction could be miniaturized.

Furthermore, in this embodiment, a thickness TH of the first substrate 250 is less than or equal to 0.3 mm. A maximum thickness MTH of the first lens 210 parallel to the optical axis 201 within an optical effective area of the first lens 210 is less than or equal to 0.4 mm.

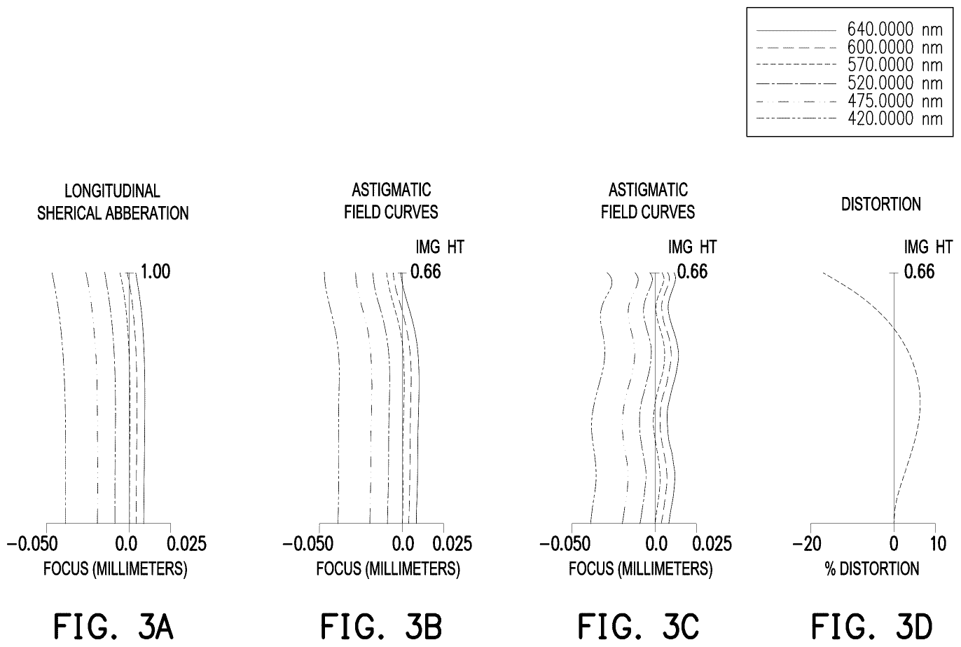

FIG. 3A to 3D are diagrams of the longitudinal spherical aberration and various aberrations of the compound lens according to the first embodiment in FIG. 2A. Referring to FIGS. 3A to 3D, FIG. 3A illustrates the longitudinal spherical aberration of the first embodiment when the wavelength are 420 nm, 475 nm, 520 nm, 570 nm, 600 nm, and 640 nm. FIGS. 3B and 3C respectively illustrates an astigmatic field curvature aberration in a sagittal direction and an astigmatic field curvature aberration in a tangential direction on the image plane 299 according to the first embodiment when the wavelength are 420 nm, 475 nm, 520 nm, 570 nm, 600 nm, and 640 nm. FIG. 3D illustrates a distortion aberration on the image plane 299 according to the first embodiment when the wavelength is 570 nm.

The longitudinal spherical aberration of the first embodiment is shown in FIG. 3A, in which a curve formed by each wavelength is very close to other curves and approaches the middle, illustrating that off-axis rays at different heights of each wavelength are concentrated near an imaging point, therefore the embodiment does significantly improve the spherical aberration of the same wavelength. In addition, distances between the six representative wavelengths are also quite close to each other, indicating that imaging positions of rays of the different wavelengths are already quite concentrated, thus, significantly improving chromatic aberration. In the two astigmatic field curvature aberration diagrams of FIGS. 3B and 3C, an amount of focal length variation of the six representative wavelengths in the entire image plane are small. This illustrates that the optical system according to the first embodiment can effectively eliminate aberration. The distortion aberration diagram of FIG. 3D shows that the distortion aberration of the first embodiment is maintained within a small range, indicating that the distortion aberration of the first embodiment has met the imaging quality requirements of the optical system.

Based on the foregoing, the compound lens 200 in the embodiments includes a first lens 210, a second lens 220, a third lens 230, and a fourth lens 240. The refractive powers of lenses are designed as: the first lens 210 is negative lens, the second lens 220 and the fourth lens 240 are positive lenses, and the third lens 230 is positive lens. Thus, when the incident lights reach the surface of the third lens 230 with the positive refractive power, the incident lights are converged, so that the lateral size of the compound lens 200 could be further designed to be smaller.

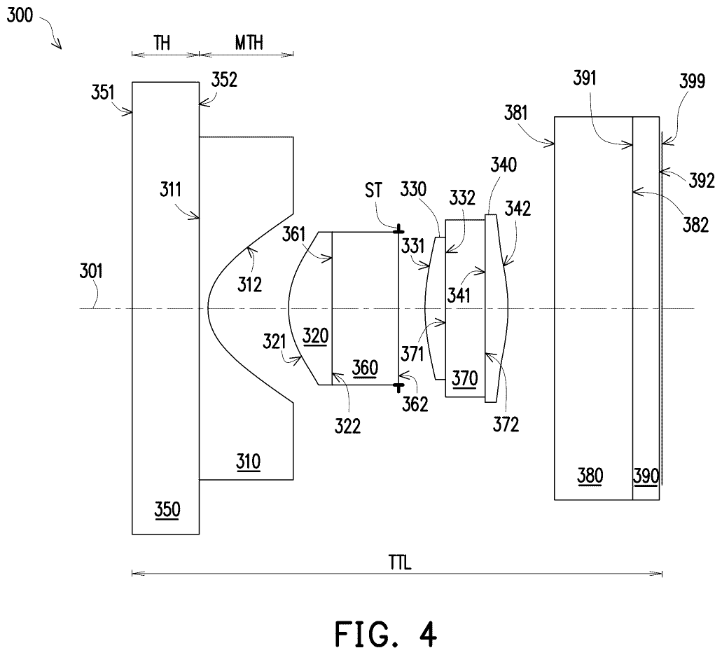

FIG. 4 is a schematic cross-sectional view of a compound lens, which is a second embodiment of the compound lens of FIG. 1. Referring to FIG. 4, the second embodiment of the compound lens 300 of the disclosure is roughly similar to the first embodiment, except for the optical data and the aspheric surface coefficients. Specifically, the compound lens 300 in this embodiment includes four coaxially aligned lenses along an optical axis 301: (i) a first substrate 350, and a first lens 310 and, in order of increasing distance therefrom, and on a same side thereof, (ii) a second lens 320, a second substrate 360, a third lens 330, a third substrate 370, and a fourth lens 340. The first substrate 350, the first lens 310, the second lens 320, the second substrate 360, the third lens 330, the third substrate 370, and the fourth lens 340 respectively has a surface 351, a surface 311, a second lens surface 321, a second planar surface 361, a third lens surface 331, a third planar surface 371, and a surface 341 facing away from an image plane 399, which could be represented as object-side surface. The first substrate 350, the first lens 310, the second lens 320, the second substrate 360, the third lens 330, the third substrate 370, and the fourth lens 340 respectively further has a first planar surface 352, a first lens surface 312, a surface 322, a surface 362, a surface 332, a surface 372, and a fourth lens surface 342 facing the image plane 399, which could be represented as image-side surface.

TABLE 3
Second embodiment
Fno = 3.5, FOV = 140°, EFL = 0.36 mm

| | | Radius of | | Refrac- | | |
|---|---|---|---|---|---|---|
| | | curvature | Thickness | tive | Abbe | Aperture |
| Element | Type | (mm) | (mm) | Index | number | (mm) |
| Object | Sphere | Infinity | 15 | | | |
| 351 | Sphere | Infinity | 0.25 | 1.52 | 63 | 0.8400 |
| 311 | Sphere | Infinity | 0.03 | 1.51 | 61 | 0.6410 |
| 312 | Asphere | 0.1807 | 0.3000 | | | 0.3565 |
| 321 | Asphere | 0.3300 | 0.1500 | 1.62 | 26 | 0.2901 |
| 361 | Sphere | Infinity | 0.25 | 1.52 | 63 | 0.2586 |
| Stop ST | Sphere | Infinity | 0.1 | | | 0.0880 |
| 331 | Asphere | 0.6000 | 0.0750 | 1.51 | 61 | 0.2410 |
| 371 | Sphere | Infinity | 0.15 | 1.52 | 63 | 0.2680 |
| 341 | Sphere | Infinity | 0.0850 | 1.51 | 61 | 0.3336 |
| 342 | Asphere | −0.7100 | 0.1700 | | | 0.3526 |
| 381 | Sphere | Infinity | 0.3 | 1.52 | 63 | 0.4868 |
| 391 | Sphere | Infinity | 0.1 | 1.52 | 63 | 0.6134 |
| Air gap | Sphere | Infinity | 0.01 | | | 0.6587 |
| 399 | Sphere | Infinity | 0 | | | 0.6667 |

The detailed optical data of the compound lens 300 according to the second embodiment is shown in Table 3. The Fno of the compound lens 300 according to the second embodiment is 3.5, the FOV is 140 degrees, and the EFL is 0.36 mm.

TABLE 4

| Surface | K | a₄ | a₆ | a₈ | a₁₀ |
|---|---|---|---|---|---|
| 312 | −0.81324505 | −0.643528475 | −21.84051365 | −845.748543 | 8878.990849 |
| 321 | −0.313581 | 0.162310254 | −68.44901672 | 20.68992947 | 7379.9522 |
| 331 | −28.4964342 | 2.973492765 | 12.55545299 | −1207.05682 | 9792.837919 |
| 342 | −3.351303 | −1.127998743 | 124.2875421 | −1708.97498 | 15032.6147 |

| Surface | a₁₂ | a₁₄ | a₁₆ |
|---|---|---|---|
| 312 | −58200.10305 | 192591.54 | −272382.2445 |
| 321 | −114577.5434 | 736098.486 | −1958877.104 |
| 331 | 0.000245312 | 0.00034987 | |
| 342 | −107101.8151 | 497744.034 | −1015878.771 |

The aspheric surface coefficients of the first lens surface 312 of the first lens 310, the second lens surface 321 of the second lens 320, the third lens surface 331 of the third lens 330, and the fourth lens surface 342 of the fourth lens 340 according to the second embodiment in the formula (1) are shown in Table 4.

Similarly, the compound lens 300 in this embodiment further includes a stop ST, a filter 380 and a cover glass 390 sequentially arranges along the optical axis 301. The stop ST is disposed between the second substrate 360 and the third lens 330. The filter 380 is disposed between the fourth lens 340 and the cover glass 390. Moreover, the filter 380 and the cover glass 390 respectively has a surface 381 and 391 facing away from the image plane 399, which could be represented as object-side surface. The filter 380 and the cover glass 390 respectively further has a surface 382 and 392 facing the image plane 399, which could be represented as image-side surface. The filter 380 may be an IR cut filter, but the disclosure is not limited thereto.

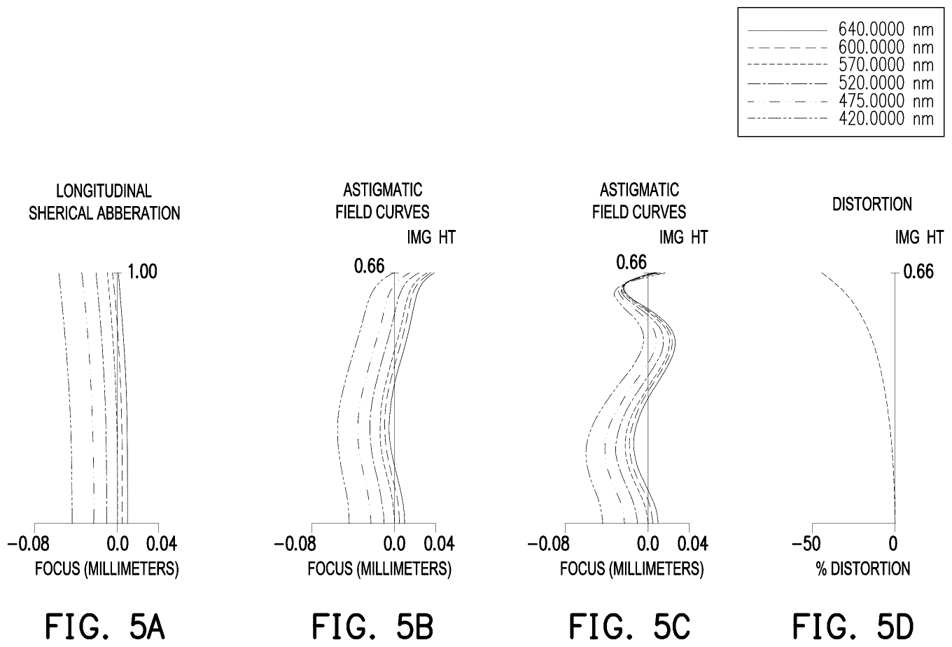

FIG. 5A to 5D are diagrams of the longitudinal spherical aberration and various aberrations of the compound lens according to the second embodiment in FIG. 4. Referring to FIGS. 5A to 5D, in this embodiment, it may be seen from FIGS. 5A to 5D that the longitudinal spherical aberration, the astigmatic field curves aberration and distortion aberration are all maintained within a small range. Thus, the compound lens 300 in the embodiments could also provide good imaging quality.

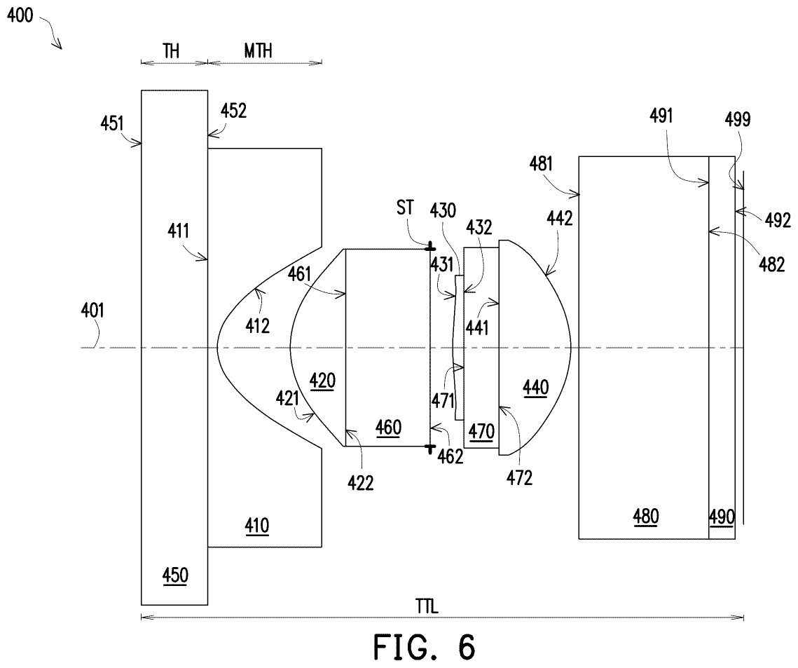

FIG. 6 is a schematic cross-sectional view of a compound lens, which is a third embodiment of the compound lens of FIG. 1. Referring to FIG. 6, the third embodiment of the compound lens 400 of the disclosure is roughly similar to the first embodiment, except for the optical data and the aspheric surface coefficients. Specifically, the compound lens 400 in this embodiment includes four coaxially aligned lenses along an optical axis 401: (i) a first substrate 450, and a first lens 410 and, in order of increasing distance therefrom, and on a same side thereof, (ii) a second lens 420, a second substrate 460, a third lens 430, a third substrate 470, and a fourth lens 440. The first substrate 450, the first lens 410, the second lens 420, the second substrate 460, the third lens 430, the third substrate 470, and the fourth lens 440 respectively has a surface 451, a surface 411, a second lens surface 421, a second planar surface 461, a third lens surface 431, a third planar surface 471, and a surface 441 facing away from an image plane 499, which could be represented as object-side surface. The first substrate 450, the first lens 410, the second lens 420, the second substrate 460, the third lens 430, the third substrate 470, and the fourth lens 440 respectively further has a first planar surface 452, a first lens surface 412, a surface 422, a surface 462, a surface 432, a surface 472, and a fourth lens surface 442 facing the image plane 499, which could be represented as image-side surface.

TABLE 5
Third embodiment
Fno = 3.5, FOV = 150°, EFL = 0.33 mm

| | | Radius of | | Refrac- | | |
|---|---|---|---|---|---|---|
| | | curvature | Thickness | tive | Abbe | Aperture |
| Element | Type | (mm) | (mm) | Index | number | (mm) |
| Object | Sphere | Infinity | 15 | | | |
| 451 | Sphere | Infinity | 0.25 | 1.52 | 63 | 0.8800 |
| 411 | Sphere | Infinity | 0.035 | 1.51 | 62 | 0.7491 |
| 412 | Asphere | 0.1713 | 0.2746 | | | 0.3795 |
| 421 | Asphere | 0.3348 | 0.2282 | 1.60 | 27 | 0.3449 |
| 461 | Sphere | Infinity | 0.3 | 1.52 | 63 | 0.3088 |
| Stop ST | Sphere | Infinity | 0.0839 | | | 0.0807 |
| 431 | Asphere | 1.1416 | 0.0418 | 1.51 | 62 | 0.2474 |
| 471 | Sphere | Infinity | 0.15 | 1.52 | 63 | 0.2723 |
| 441 | Sphere | Infinity | 0.2529 | 1.51 | 62 | 0.3914 |
| 442 | Asphere | −0.3555 | 0.0436 | | | 0.4054 |
| 481 | Sphere | Infinity | 0.5 | 1.52 | 63 | 0.5143 |
| 491 | Sphere | Infinity | 0.1 | 1.52 | 63 | 0.6378 |
| Air gap | Sphere | Infinity | 0.01 | | | 0.6625 |
| 499 | Sphere | Infinity | 0 | | | 0.6664 |

The detailed optical data of the compound lens 400 according to the third embodiment is shown in Table 5. The Fno of the compound lens 400 according to the second embodiment is 3.5, the FOV is 150 degrees, and the EFL is 0.33 mm.

TABLE 6

| Surface | K | a₄ | a₆ | a₈ | a₁₀ |
|---|---|---|---|---|---|
| 412 | −0.9339472 | −3.847257558 | 33.82872439 | −686.598033 | 8522.265319 |
| 421 | −0.2673117 | −1.591067948 | −14.327135 | −249.148904 | 7821.104664 |
| 431 | −9.7281288 | −4.927403319 | 79.97100213 | −1025.02573 | 814.9638337 |
| 442 | −4.5785564 | −7.323109537 | 105.7137047 | −1332.94241 | 13692.78443 |

| Surface | a₁₂ | a₁₄ | a₁₆ |
|---|---|---|---|
| 412 | −58289.103 | 192591.54 | −272382.24 |
| 421 | −114577.54 | 736098.485 | −1958877.1 |
| 431 | 7.693E−07 | 1.1037E−06 | |
| 442 | −107101.82 | 497744.034 | −1015879.7 |

The aspheric surface coefficients of the first lens surface 412 of the first lens 410, the second lens surface 421 of the second lens 420, the third lens surface 431 of the third lens 430, and the fourth lens surface 442 of the fourth lens 440 according to the third embodiment in the formula (1) are shown in Table 6.

Similarly, the compound lens 400 in this embodiment further includes a stop ST, a filter 480 and a cover glass 490 sequentially arranges along the optical axis 401. The stop ST is disposed between the second substrate 460 and the third lens 430. The filter 480 is disposed between the fourth lens 440 and the cover glass 490. Moreover, the filter 480 and the cover glass 490 respectively has a surface 481 and 491 facing away from the image plane 499, which could be represented as object-side surface. The filter 480 and the cover glass 490 respectively further has a surface 482 and 492 facing the image plane 499, which could be represented as image-side surface. The filter 480 may be an IR cut filter, but the disclosure is not limited thereto.

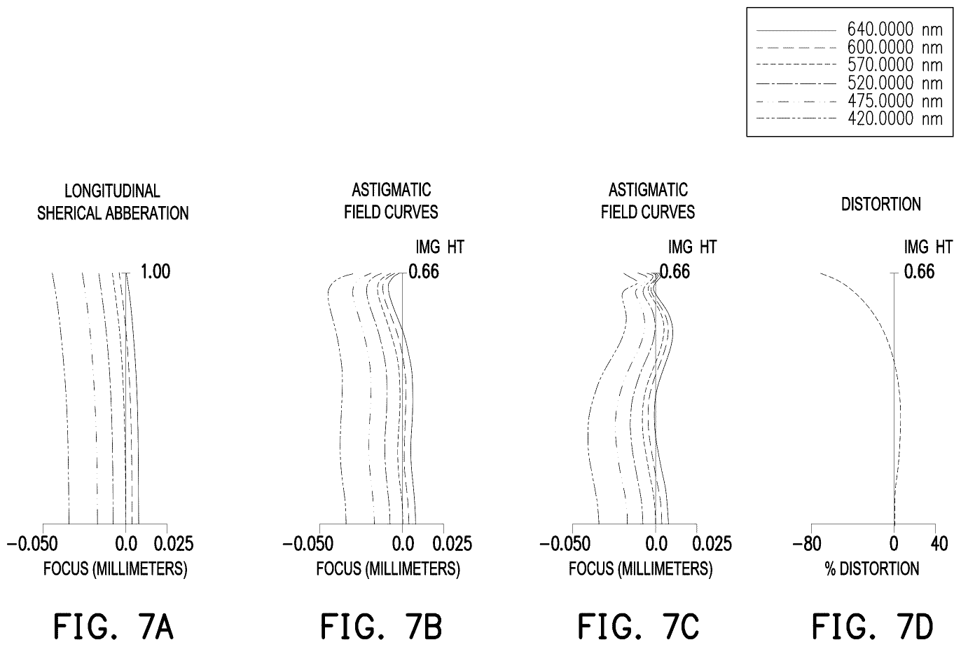

FIG. 7A to 7D are diagrams of the longitudinal spherical aberration and various aberrations of the compound lens according to the third embodiment in FIG. 6. Referring to FIGS. 7A to 7D, in this embodiment, it may be seen from FIGS. 7A to 7D that the longitudinal spherical aberration, the astigmatic field curves aberration and distortion aberration are all maintained within a small range. Thus, the compound lens 400 in the embodiments could also provide good imaging quality.

In conclusion, the compound lens in the embodiments includes a first lens, a second lens, a third lens, and a fourth lens. Moreover, the first lens is negative lens, the second lens, the third lens is positive lens, and the fourth lens are positive lenses. Thus, when the incident lights reach the surface of the third lens with the positive refractive power, the incident lights are converged, so that the lateral size of the compound lens could be further designed to be smaller.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A compound lens comprising: four coaxially aligned lenses including (i) a first substrate, and a first lens and, in order of increasing distance therefrom, and on a same side thereof, (ii) a second lens, a second substrate, a third lens, a third substrate, and a fourth lens;
wherein the first lens is negative lens; and
wherein the second lens, the third lens and the fourth lens are positive lenses.

2. The compound lens of claim 1, wherein the first substrate has a first planar surface facing an image plane, and the first lens is bonded to the first planar surface and has a first lens surface which is paraxial concave facing the image plane.

3. The compound lens of claim 1, wherein the second substrate has a second planar surface facing away from an image plane, and the second lens is bonded to the second planar surface and has a second lens surface which is paraxial convex facing away from the image plane.

4. The compound lens of claim 1, wherein the third substrate has a third planar surface facing away from an image plane, and a third lens is bonded to the third planar surface and has a third lens surface which is a paraxial convex facing away the image plane.

5. The compound lens of claim 1, wherein the third substrate has a fourth planar surface facing an image plane, and the fourth lens is bonded to the fourth planar surface and has a fourth lens surface which is a paraxial convex facing the image plane.

6. The compound lens of claim 1, wherein the compound lens satisfies a following conditional expression: 1.3<TTL/D<2.1, where TTL is a total track length from a surface of the first substrate facing away from an image plane to the image plane, and D is a diagonal diameter of the image plane.

7. The compound lens of claim 1, wherein the compound lens satisfies a following conditional expression: −2.1<R4/F<−0.8, where R4 is a radius of a fourth lens surface of the fourth lens facing an image plane, and F is an effective focal length of the compound lens.

8. The compound lens of claim 1, wherein a thickness of the first substrate is less than or equal to 0.3 mm.

9. The compound lens of claim 1, wherein a maximum thickness of the first lens parallel to an optical axis within an optical effective area of the first lens is less than or equal to 0.4 mm.
